(19) United States
(12) Patent Application Publication
(10) Pub. No.: US 2007/0286178 A1
(43) Pub. Date: Dec. 13, 2007

(54) IP TELEPHONE SYSTEM AND TELEPHONING METHOD

(76) Inventors: Hiroyuki Kakiuchi, Yokohama (JP); Hiroshi Kodaka, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/752,346

(22) Filed: May 23, 2007

(30) Foreign Application Priority Data
May 23, 2006 (JP) 2006-142226

(51) Int. Cl. H04L 12/66

(52) U.S. Cl. 370/356

(57) ABSTRACT

An IP telephone includes a unit that reads out own telephone number information, and a unit that notifies, to a PC, the telephone number information read out through a network, in which the PC also includes a unit that receives the notification from the IP telephone. According to the constitution, the PC and IP telephone can be cooperated dynamically with each other without presetting a telephone number etc. thereto. Further, in the case where a softphone is installed in the PC, a call directed to the softphone is transferred automatically to the IP telephone by the softphone, enabling the IP telephone to be used in substitution for a handset of the softphone.

### INCORPORATION BY REFERENCE

The present application claims priority from Japanese application JP 2006-142226 filed on May 23, 2006, the content of which is hereby incorporated by reference into this application.

### BACKGROUND OF THE INVENTION

The present invention relates to an IP telephone system, and particularly to an IP telephone system having an IP telephone, a personal computer (PC) with a softphone.

In recent years, IP telephones have been widely used rapidly. According to this, particularly, there is a tendency for the IP telephone system to be introduced into an extension telephone network in business organizations. The IP telephone means a scheme to transmit and receive data such as sounds by using VoIP (Voice over IP) technique in a network.

As a scheme of the IP telephone, there has been proposed mainly a system for implementing the IP telephone using SIP (Session Initiation Protocol) specified in RFC (Request For Comment) 3261 which is one of the documents of Internet. The system has realized so that binding information indicating a corresponding relationship between an own telephone number and an IP address by an incoming call device, which generates a telephone call, is registered in an IP telephony server (or SIP server). The system has also realized a telephone system to provide a terminal management made by implementation of a register processing which updates periodically the biding information and exchange the control data and sound data on the network system.

There are also various types of IP telephones for use in the IP telephone system. For example, there are a fixed IP telephone connected directly to an IP network in use, and a radio telephone terminal which incorporates a telephone application program referred to as a softphone and is connected to the IP network through a softphone telephone terminal made up of a PC including a speaker and a microphone and also through a radio LAN access point. Further, there exists a hub built-in IP telephone having a built-in hub device connectable with the PC, as a fixed IP telephone, to be able to make wirings on the desk simple. That is, this is a hub built-in IP telephone connectable with a PC in which a hub device including a LAN port for connection with the PC and a LAN port for connection with a high-level network accommodation device is built therein.

Further, on the other hand, in the IP telephone system, there have been various proposed examples for a purpose of enhancing convenience in use of a telephone. For example, in order to eliminate errors caused by seeing a telephone number and by depressing keys in calling a telephone, there is an IP telephone system to make call automatically by cooperation with a PC without depressing buttons by user (a telephone book application provided in the PC is initiated, and a predetermined telephone number is selected from telephone number information registered in the telephone book to then call automatically a terminal of the selected telephone number).

There have been JP-2001-127902 and JP-2003-283700 as the foregoing example.

However, in the case of these IP telephones and IP telephone systems, it is required that fixed telephones as call sources are registered in the IP telephony server etc. capable of implementing a call setup and a telephone call between the IP telephones, in advance.

In the meantime, work styles in business organizations have also been innovatively changed in accordance with the evolutions of network systems and of communication devices as typified by the IP telephone. For example, a work style has been proposed and practically implemented for employees who are not provided with their own desks and seats, and work at their favorite places or desks. A so-called layout-free office style (new work style) has been proposed and implemented for employees who can freely change their desks and seats in accordance with their business projects.

Since the IP telephone system is convenient so that construction works are unnecessary for the relocation of IP telephones and it can be used as a so-called Plug and Play, a desk on which a PC and an IP telephone are installed can be an own place environment in any desk and seat.

In the case of the foregoing IP telephone system, commonly used desks are provided in a working place for employees who often take their business trips and a place within a business organization etc. to which employees visits. That is, a layout-free office style is introduced in business organizations, specifically, a so-called “free-address system” is introduced so that the employees can work at any places without setting a desk and a seat to them. To this end, it becomes easy to work for their responsibilities beyond organization barriers, and it is also possible to reduce a wasted space at least because employees' seats, which are highly unoccupied rates, are not provided. It is therefore possible to expect effects so that the reduction of office expense and the change of organizations can be carried out speedily and flexibly.

### SUMMARY OF THE INVENTION

However, the IP telephone system, IP telephone device, softphone, etc. have not considered specifically even of the relationship with the foregoing new office style and work style. That is, they have not been assumed as utilization in environment in which a fixed telephone to be connected to the IP network in each call is changed and an IP address of a call control device is also changed.

In the layout-free office style, generally, the IP telephone and PC are physically connectable and located in an extremely close distance with each other in the case of considering an aspect of using the foregoing hub built-in IP telephone, it is therefore convenient that the IP telephone can be utilized by operation from the PC. As described the related art above, in the case of a system for carrying out a telephone call with use of the PC and a telephone talk by using the IP telephone in order to realize the foregoing function, it is required that an IP address and telephone number information to be used are set to the PC in advance and managed them therein. Therefore, in the case where an IP telephone to be used is changed everyday and the IP addresses of the PC and IP telephone are also changed, there is a problem not to be able to adapt dynamically and automatically such changes.

With log-in to the IP telephone by a user ID and a password, it may be considered to change the IP telephone to a telephone being allotted with a user individual telephone number. However, in this case, there arises a problem with the telephone which does not connect when a call is directed to a telephone number before the log-in has been implemented.

It is therefore an object of the present invention to provide a suitable IP telephone, etc. for use in an layout-free office environment.

It is a further object of the present invention to provide an IP telephone and an IP telephone system in which the IP telephone can be used in substitution for a handset of a softphone in a PC, by only connecting the PC with a hub built-in IP telephone. The IP telephone and IP telephone system can receive both a call directed to the IP telephone and a call directed to the softphone.

In order to achieve the above-mentioned objects, the IP telephone in the invention provides a unit that reads out own telephone number information of the IP telephone and notifies the read out telephone number information to a PC. The PC provides a unit that receives the notification from the IP telephone.

The telephone number information of the IP telephone is notified to the PC by using the notification unit when the PC is connected with the IP telephone. The PC receives the notification and detects that the IP telephone exists. Therefore, the PC and IP telephone are constituted so that they can be cooperated with each other without presetting a telephone number etc. thereto.

In the case where the softphone is installed in the PC, the telephone number information of the IP telephone can be acquired by the above-mentioned unit. Therefore, when a call is directed to the softphone, the call is transferred automatically to the IP telephone by the softphone. As a result, the IP telephone can be used in substitution for a handset of the softphone.

According to the present invention, a suitable IP telephone can be provided for use in a layout-free office environment (free-address system).

For example, dynamic cooperation between the IP telephone and PC can be realized by only connecting the PC with the hub built-in IP telephone installed on a desk, without presetting a telephone number etc. thereto.

Further, in the case where the softphone is installed in the PC, the IP telephone can be used in substitution for the handset of the softphone, both a call directed to the softphone and a call directed to the IP telephone can be received by the IP telephone, and the IP telephone can implement a substitute response to the call directed to the softphone which belongs to a neighbor who sits beside, in such a way that the telephone numbers of IP telephones allocated on land-like desk and seats, respectively (a block constituted of a desired area with a plurality of desks which are put together) are set only in a group.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a connection example of a hub built-in IP telephone and a softphone to a network in an embodiment of the present invention;

FIG. 2 is a pictorial diagram showing a constitutional example of a general IP telephone and PC in LAN;

FIG. 3 is an imaged block diagram showing a hub built-in IP telephone;

FIG. 4 is a pictorial diagram showing a connection constitutional diagram of the hub built-in IP telephone;

FIG. 5 is a constitutional diagram showing the hub built-in IP telephone for implementing the present invention;

FIG. 6 is a block diagram showing the PC carrying out cooperation with the IP telephone for implementing the present invention;

FIG. 7 is a block diagram showing the PC;

FIG. 8 is a block diagram showing a notification cooperating unit;

FIG. 9 is a flow chart showing a notification processing unit;

FIG. 10 is a flow chart showing a notification receiving processing;

FIG. 11 is a flow chart showing an incoming call processing;

FIG. 12 is a diagram showing a call connection sequence;

FIG. 13 is a pictorially imaged diagram showing a layout-free office style in the present invention; and

FIG. 14 is a block diagram showing a constitution of a general IP telephone system.

### DESCRIPTION OF THE EMBODIMENTS

A suitable IP telephone system is realized with a simple constitution for use in a layout-free office environment.

Hereinafter, embodiments in the invention will be described on the basis of the drawings. FIG. 14 is a block diagram showing a schematic constitution of a general intra-firm IP telephone system.

In FIG. 14, an IP telephony server (also, referred to as SIP server) 11 (hereinafter, referred to as IPT server 11) manages telephone terminals or IP telephones 12, 13, 14 in an extension telephone system connected with an IP network 18 so that a call control is carried out for telephonic exchange between the telephone terminals or IP telephones. That is, respective extension numbers, IP addresses, etc. of the IP telephones 12, 13, 14 are managed by their own management tables, respectively, to thereby realize call connection controls and call managements between the IP telephones. There are various types of telephone terminals.

It is necessary to allot an IP address and a telephone number to all of the IP telephones 12, 13, 14, when the extension IP telephone system is established. Likewise, it is also necessary to register setting information (telephone number information, IP addresses, etc.) of the telephone terminals to the IPT server 11 as management information, as described above. Such consistency between their setting contents is made properly, so that the extension IP telephone system is functioned. In the IP telephone system, if an IP telephone etc. coped with the protocol, for example, LLDP (link layer discovery protocol) for automatically detecting a device coupled to a network is used, the setting of the device (setting of an IP address etc.) can be automated (see NIKKEI COMMUNICATIONS published by Nikkei Business Publication Inc., Apr. 1, 2007, p. 36 and NIKKEI COMMUNICATIONS published by Nikkei Business Publication Inc., May 1, 2007, pp. 68-73).

Desk-installed IP telephones corresponding to the IP telephones 12, 13 in FIG. 14 are constituted so that their wirings are made simple in consideration of compatibility with a personal computer (PC) 15. A hand set 16 and a head set 17 are also available through the PC 15.

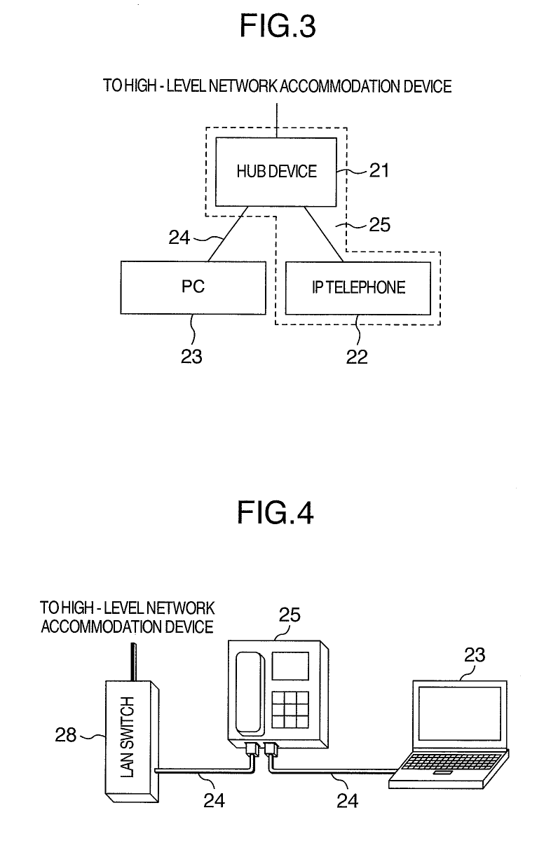

FIG. 2 is a pictorial diagram showing a hub built-in IP telephone as an aspect described above. As shown in FIG. 3, the hub built-in IP telephone device 25 is constituted by an IP telephone 22 having the function of IP telephone and a hub device (network connection device) 21 for connecting the PC etc. The hub device 21 includes an interface unit (connection unit) having a LAN port 26 (FIG. 2) for connection with a high-level network accommodation device and a LAN port 27 (FIG. 2) for connection with a PC 23 through a LAN cable 24, which is constituted so that the respective devices can be communicated with each other. Thus, the logical configuration of the hub built-in IP telephone device 25 on a network in a case where a PC is coupled to the hub built-in IP telephone device 25 is shown in FIG. 3. As clear from this figure, the PC and the IP telephone device are coupled to the hub device 21. As the hub device 21, a known hub device may be used and so the detailed explanation thereof will be omitted.

FIG. 4 is a pictorial diagram showing a connection example among the hub built-in IP telephone device 25, a LAN switch 28, and the PC 23. In FIG. 4, the hub built-in IP telephone device 25 is connected with the LAN switch 28 by using the LAN cable 24. The PC 23 can also be connected with the hub built-in IP telephone device 25 through the LAN cable 24. In this way, the IP telephone described above is particularly desirable for use in offices since the wirings on a desk can be made simple.

Further, in the environment where the softphone is installed in the PC 23, the foregoing hub built-in IP telephone device and a neighboring IP telephone may be cooperated with the softphone in the reception. For example, The softphone and IP telephone cooperated with it are set as the same telephone number in advance, and both the softphone and IP telephone ring when a call is received. Therefore, either one of first off-hooking a terminal or receiver can be connected with an opponent party.

As an embodiment to be realized similar effect on the foregoing example, all of the telephone terminals in a group setting can be ringed for an incoming call if a plurality of telephone numbers are set to a device for managing the telephone system as a group in advance. That is, there has been a system so called a group incoming call in PBX (Private Branch Exchange) function.

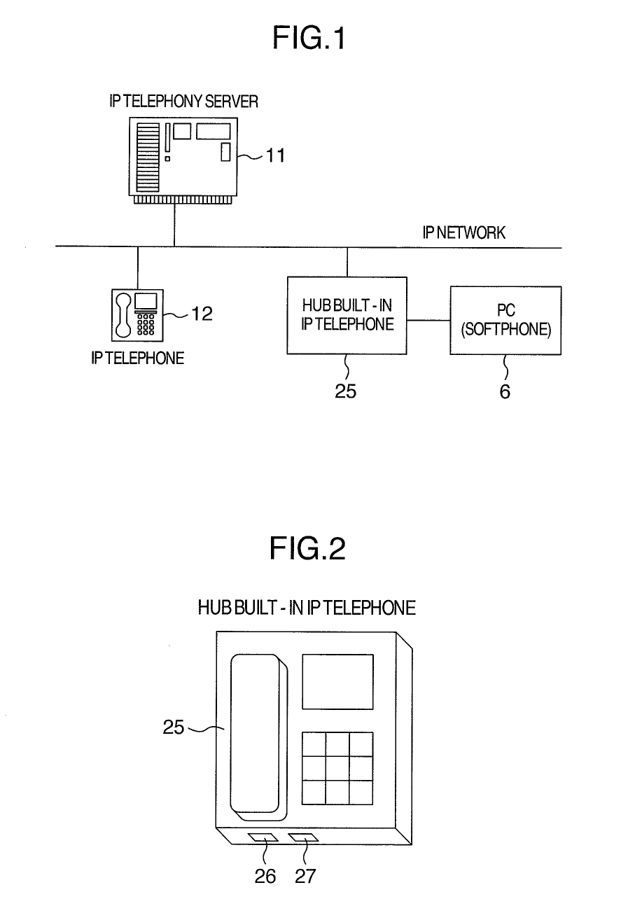

In the application examples of IP telephone, as described above, the invention provides an IP telephone suitable for the foregoing new work style. For example, as shown in FIG. 1, when a PC having a softphone adapted to the control of IP telephone has been connected with an interface unit (connection unit) corresponding to the LAN port 27 (FIG. 2) of hub built-in IP telephone device 25, such connection is detected, and a device including a processing unit is provided to notify own-telephone number information of the hub built-in IP telephone device 25 to the softphone connected with the PC. As a method of detecting the connection of PC, it is possible to employ a method of detecting the connection in hardware by a Link Up detection (refer to Link Up detection unit 411 in FIG. 6) of the connection unit, when the PC has been connected with the IP telephone. This method is however not limited to the invention, other methods may be applicable. For example, a method of detecting the connection by manual may also be applicable. The device including the processing unit for carrying out the notification may be constituted to receive the notification of connecting detection, read out the own telephone number information registered to a memory in advance, and be able to transmit it to the PC.

A foregoing example will be described below. FIG. 1 is a block diagram showing a connection example of a hub built-in IP telephone and a softphone to a network in an embodiment of the invention.

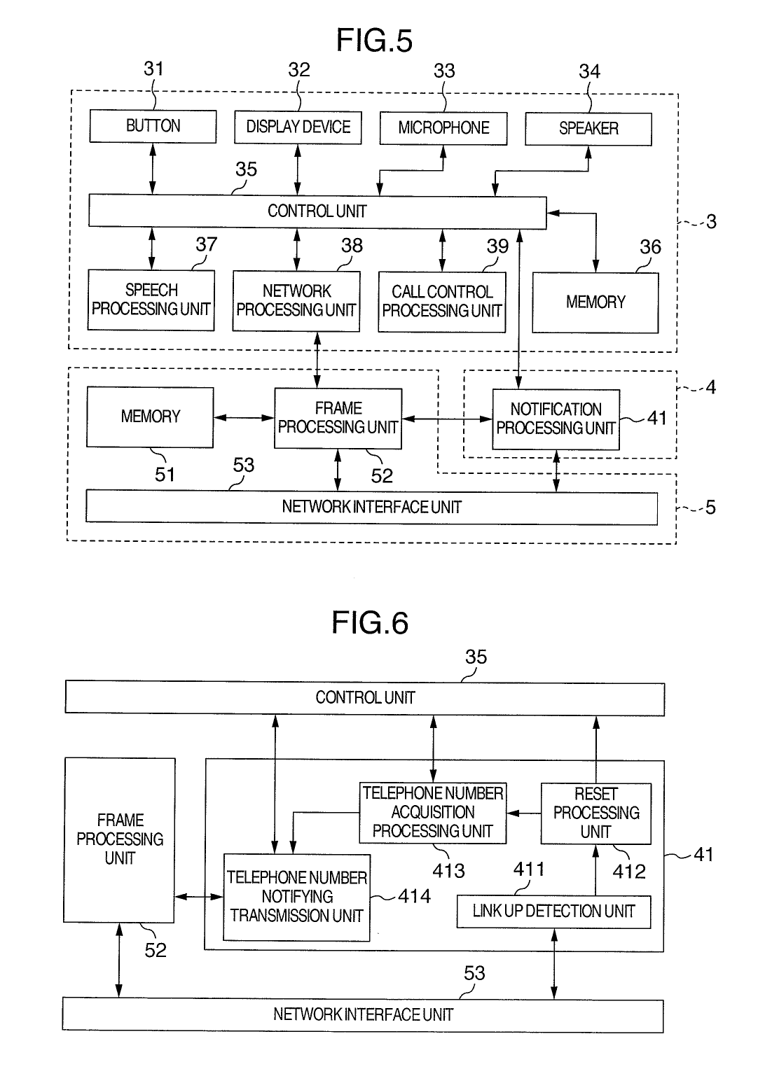

In FIG. 1, a reference numeral 6 denotes a personal computer (PC) incorporated with a softphone. The personal computer (softphone), as designated on FIG. 1, is connected with an IP network through a hub device unit 5 (FIG. 5) in the hub built-in IP telephone device 25.

FIG. 5 is a schematic constitutional diagram showing a hub built-in IP telephone. As shown in FIG. 2 and FIG. 3 as described above, the hub built-in IP telephone device 25 is basically constituted by the IP telephone 22 having an IP telephone function, and the hub device 21 including the LAN port 26 for connection to the high-level network accommodation device and the LAN port 27 for connection to the personal computer (PC). Further, in the invention, the IP telephone 22 is connected with the hub device 21. A notification processing unit is provided for notifying, to the PC, telephone number information of the IP telephone 22. Constitution as described above will be described below.

In FIG. 5, a reference numeral 3 denotes an IP telephone (corresponding to IP telephone 22 in FIG. 2) of the hub built-in IP telephone device 25. The IP telephone 3 is constituted with: an operation unit including a button 31 for entering telephone numbers etc.; a receiver unit including a display unit 32 containing a display for displaying the telephone number information etc., a microphone 33, and a speaker 34; a memory 36 for storing various programmings and setting information; a speech processing unit 37 for implementing an encode/decode processing of speech information; a network processing unit 38 for implementing a communication processing of data communication, speech communication, etc.; a call control processing unit 39 for implementing a call control processing in the IP telephone system; and a control unit 35 for controlling the foregoing units.

A reference numeral 5 denotes a hub device (corresponding to hub device 21 in FIG. 3). The hub device 5 is constituted with: a memory 51 for storing information such as frames; a frame processing unit 52 for implementing a processing of the frames that flows on the network; and a network interface unit 53 for implementing transmission and reception of information through the LAN cable 24 (FIG. 4). The frame is constituted with: a UDP (User Datagram Protocol) package containing a transmission destination port, a transmission source port and various messages; an IP packet containing the UDP package, a transmission destination IP address, and a transmission source address; a transmission destination MAC address; and a transmission source MAC address, etc. The IP telephone 3 and hub device 5 constitute the general hub built-in IP telephone device 25 as shown in FIG. 2 and FIG. 3, therefore, detailed description for the foregoing FIG. 2 and FIG. 3 in relation to the hub built-in IP telephone device is omitted because their constitution and operation are well known.

A reference numeral 4 denotes a notification processing device connected with the network interface unit 53, the frame processing unit 52, and the control unit 35 in the IP telephone 3. The notification processing device 4 notifies the telephone number information of IP telephone itself to the PC. The notification processing device 4 is provided with a notification processing unit 41.

FIG. 6 is a block diagram showing a processing function constituted of the notification processing unit 41 in detail. The notification processing unit 41 includes: a Link Up detection unit 411 for detecting that the PC has been connected to the network interface unit 53 in the IP telephone; a reset processing unit 412 for resetting information (telephone number information) present in a memory area of the memory 36 which is used by the notification processing unit 41; a telephone number acquisition processing unit 413 for reading out and acquiring a telephone number allotted to the IP telephone from the IP telephone 3; and a telephone number notifying transmission unit 414 for transmitting the acquired telephone number information to the PC 6 (FIG. 1) through the hub device 5 (FIG. 5). Notification processing steps for the telephone number information will be described later.

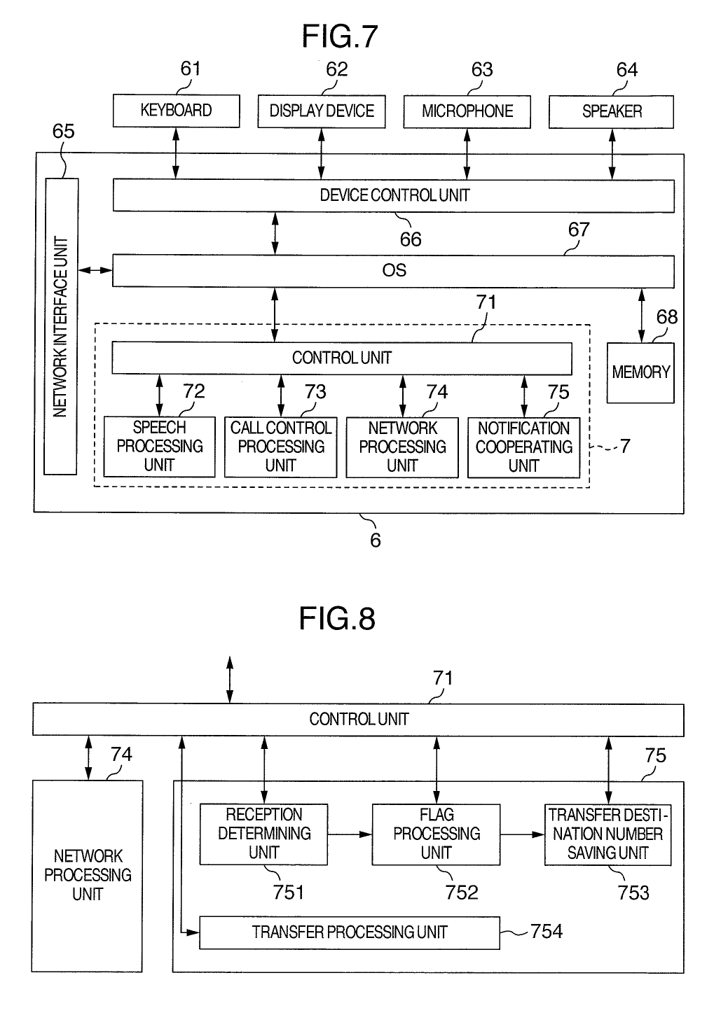

FIG. 7 is a block diagram functionally showing a logical constitutional example of PC (softphone) 6 cooperative with the IP telephone 3 which is connected through the LAN cable 24 (FIG. 4) and the hub device 5 (network interface unit). In FIG. 7, a keyboard 61, a display device 62, a microphone 63 and a speaker 64 are connected to the PC (softphone) 6, and are constituted of input and output devices for the PC (softphone) 6. The PC (softphone) 6 includes: a basic function unit including an OS 67 for implementing a basically various processing of the PC; a device control unit 66 for implementing controls of various devices such as the input and output devices; a network interface unit 65 for implementing transmission and reception of information for such as data communication and speech communication; and a memory 68 for storing programming to execute various processings in the PC (softphone) 6 and storing setting information (telephone number information and IP addresses). In addition to the basic function unit, the PC (softphone) 6 provides a softphone 7 to be installed. The softphone 7 is constituted with: a control unit 71 for controlling respective processing units; a speech processing unit 72 for controlling an encode and decode processing etc. of the speech information; a call control processing unit 73 for implementing a call connection processing in the IP telephone system; a network processing unit 74 for implementing a communication processing relative to the softphone for the data communication and speech communication; and a notification cooperating unit 75 for receiving a telephone number information notification from the IP telephone 3.

FIG. 8 is a block diagram showing a processing function constituted of the notification cooperating unit 75 in further detail. The notification cooperating unit 75 includes: a reception determining unit 751 for implementing a reception and a receiving determination of the telephone number information notification transmitted from the IP telephone; a flag processing unit 752 for setting a cooperation processing flag in response to presence and absence of receiving the telephone number information; a transfer destination number saving unit 753 for saving the received telephone number information (transfer destination number); and a transfer processing unit 754 for implementing a processing of transferring, to the IP telephone, a telephone call directed to the softphone in response to the ON state of the cooperation processing flag.

The softphone 7 can be realized with the functions included in the general PC and softphone, except the notification cooperating unit 75 in the PC 6. Therefore, detailed descriptions for other units are omitted. In FIG. 8, the notification cooperating unit 75 is described as a component including the softphone 7. However, the notification cooperating unit 75 can be cooperated with the IP telephone 3 if it exists in the PC as a programming even though the softphone does not exist.

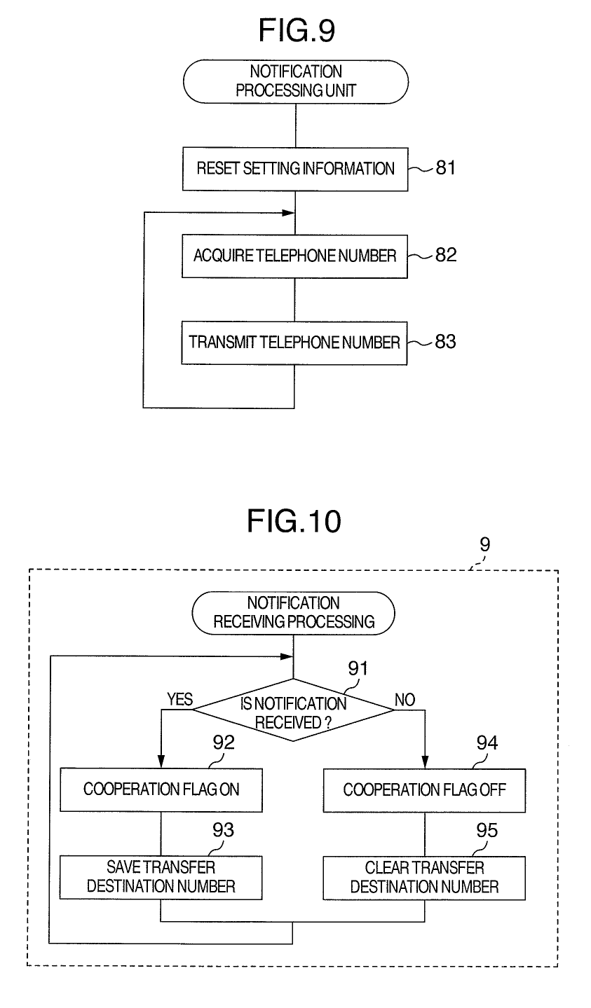

FIG. 9 is a flow chart showing a processing flow in the notification processing unit 41 (FIG. 5) from which the telephone number information of the IP telephone 3 is notified to the PC (softphone) 6. A processing flow starts when the Link Up detection unit 411 (FIG. 6) detects that the PC is connected with the network interface unit of IP telephone. The processing along the flow chart is only implemented for the LAN port (referring to LAN port 27 shown in FIG. 2) to be connected with the PC (softphone) 6, but not implemented for the other ports.

First, in step 81, the reset processing unit 412 (referring to FIG. 6) resets a predetermined storage area in which the setting information (telephone number information) of the reset processing unit 412 in the memory 36 (FIG. 5) is stored.

Next, in step 82, the telephone number acquisition processing unit 413 (referring to FIG. 6) reads out the telephone number information being set in the IP telephone 3 to then save to the predetermined storage area in the memory 36 (FIG. 5). Subsequently, in step 83, the telephone number notifying transmission unit 414 (referring to FIG. 6) takes out the telephone number information which was saved by the previous step and sends it to the frame processing unit 52 (FIG. 5). In this way, the telephone number information is transmitted to the PC (softphone) 6 through the network interface unit 53.

Here, when the IP telephone 3 notifies the telephone number information to the PC (softphone) 6 at first, the telephone number information cannot be transmitted thereto if address information for an opponent side terminal is unknown. A scheme of broadcast in the Ethernet network is therefore used. In this way, the telephone number information can be transmitted (telephone number information notification) even though the opponent party address information is unknown. After transmitted the telephone number information notification, the processing returns again to the step 82, and the foregoing processings are repeated. For this reason, telephone number information of a new IP telephone can be notified automatically to the PC (softphone) 6 even though the telephone number of IP telephone 3 has been changed by any cause.

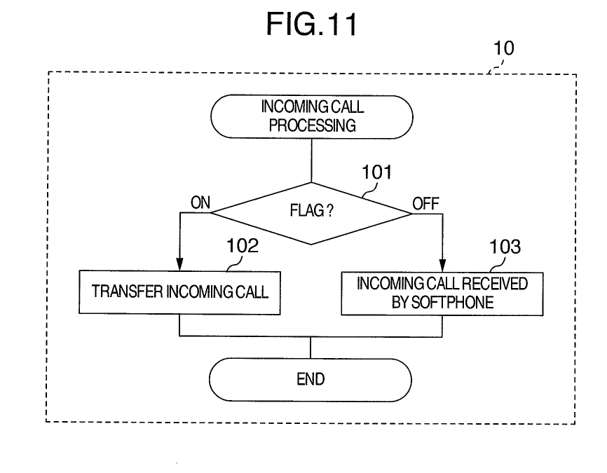

FIG. 10 and FIG. 11 are flow charts showing processings of the notification cooperating unit 75 in the PC (softphone) 6 shown in FIG. 7. The notification cooperating unit 75 is constituted with a notification receiving processing 9 and an incoming call processing 10.

The notification receiving processing 9 in FIG. 10 will be described first. In step 91, the reception determining unit 751 (referring to FIG. 8) determines a reception of notification information (telephone number information) from the notification processing unit 41 in the IP telephone. As a result of the determination, if the reception is determined (Yes), the flag processing unit 752 (referring to FIG. 8) in step 92 sets a predetermined storage area for storing flag information in the memory 68 (FIG. 7) ON. In step 93, the transfer destination number saving unit 753 (referring to FIG. 8) saves the telephone number information received as the notification information to the predetermined storage area for saving the transfer destination telephone number information in the memory 68. If the reception in the step 91 is not determined (No), in step 94, the flag processing unit 752 (referring to FIG. 8) sets the predetermined storage area for storing the flag information in the memory 68 OFF. In step 95, the transfer destination number saving unit 753 (referring to FIG. 8) makes a value of the predetermined storage area for saving the transfer destination telephone number information in the memory 68 clear. Subsequently, the foregoing processings and determinations are repeated.

The incoming call processing 10 in FIG. 11 will be described next. In FIG. 11, the processing starts at a time when an incoming call is present and directed to the softphone 7. In step 101, the transfer processing unit 754 (referring to FIG. 8) determines a content of the flag information (ON/OFF) in the memory 68 which has been set by the steps 92, 94 in the notification receiving processing 9 of FIG. 10. If a flag bit is ON, the processing responds to the incoming call in step 102. In the step 93 of the notification receiving processing 9 (FIG. 10), a transfer processing is implemented to transfer the call to a transfer destination telephone number which is saved to the predetermined storage area for the transfer destination telephone number information in the memory 68. If the flag bit is OFF, an incoming call operation processing is implemented by the softphone 7 in step 103.

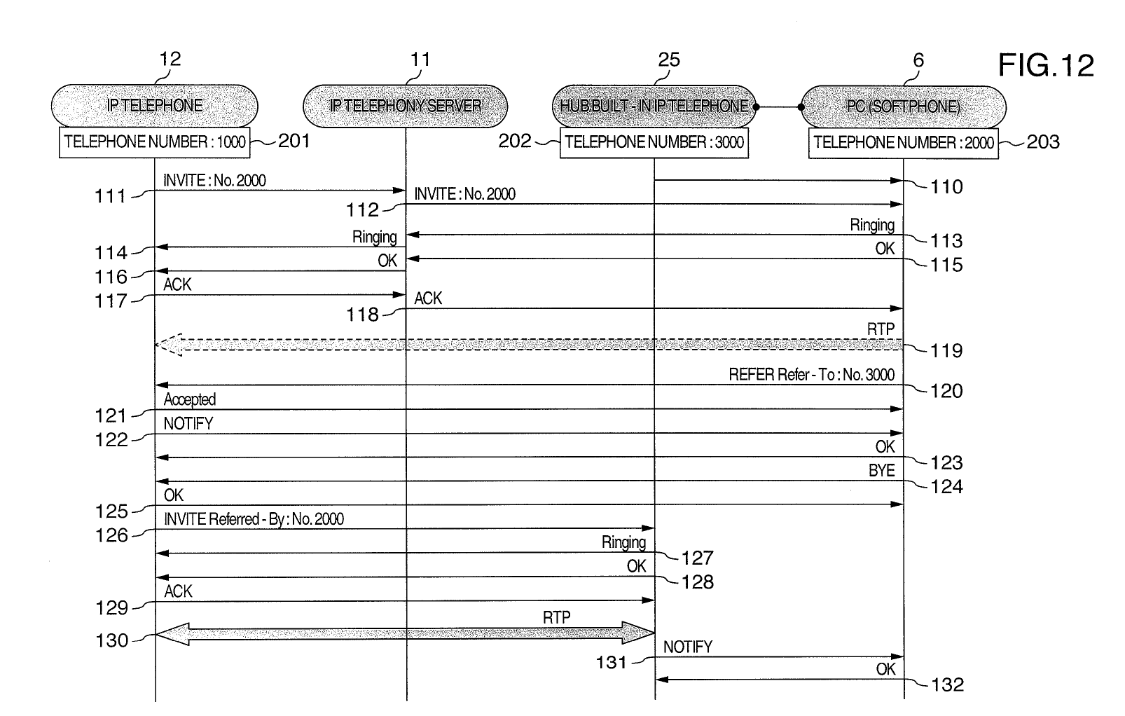

Incidentally, in the step 102, it takes normally a few seconds even at lowest from when the processing responds to the incoming call to when the call is transferred to the IP telephone 25 (FIG. 1) and completed. During this time, confusion occurs easily in user because a person who makes call is sustained from a waiting state with silence. So, it is easily implemented that a message such as “we are calling right now” is sent to the call source (IP telephone 12 in FIG. 1) during the time from when the processing responds to the incoming call to when the transfer processing of the call is completed, in the step 102 (referring to the description of step 119 in FIG. 12).

FIG. 12 is a call connection sequence (SIP sequence) applicable to FIG. 1, as an example, in which the cooperation flag is set by the processing of notification cooperating unit 75 (FIG. 8) in PC 6, and when an incoming call is directed to the softphone 7, its call is transferred to the transfer destination telephone number which is set by the foregoing steps. The SIP sequence is a call connection sequence incorporated in the generally used IP telephone system, which can be realized by functions of normal IP telephone system.

The IP telephone 12, hub built-in IP telephone 25 and PC (softphone) 6, shown in FIG. 12, are set by unique telephone numbers for identifying the devices and terminals, respectively, that is, the telephone number 201 (No. 1000), 202 (No. 3000), and 203 (No. 2000), respectively. Incidentally, at this time, the respective IP telephones are in a state to be resisted in an IPT (IP Telephony) server 11.

First, when the hub built-in IP telephone 25 is connected with the PC (softphone) 6, as described with FIG. 9, information of the telephone number 3000 of the hub built-in IP telephone 25 is transferred to the softphone 7 (step 110). The softphone 7 receives and saves the telephone number information (transfer destination telephone number information), as described with FIG. 10.

Next, when the IP telephone 12 as a call source makes call to No. 2000 of the softphone 7, an incoming call notification is implemented to the softphone 7 (step 111, step 112). The softphone 7 notifies “calling now” to the IP telephone 12 (step 113, step 114), and also notifies a response to “off hook” thereto (step 115, step 116). The IP telephone 12, which has received a response notification, implements a notification of reporting a confirmed call connection (step 117, step 118). The foregoing processing is implemented through the IPT server 11. A telephonic exchange between the IP telephone 12 and the softphone 7 on the call connection sequence starts by sending the call connection notification to the softphone 7 (step 119).

Here, the softphone 7 in the invention implements the transfer processing of the call to the hub built-in IP telephone 25 in accordance with the processing procedure in the foregoing step 102 in FIG. 11, therefore, the telephone talk in step 119 does not awake user in the incoming call side from the calling state since the telephone talk is processed internally. Further, at this time, as described with FIG. 11 above, another embodiment to be intended to enhance convenience for users can be assumed that a message such as “we are calling right now” is sent to the IP telephone 12.

Hereinafter, an example of the transfer procedure will be described subsequently with the call connection sequence in FIG. 12. The softphone 7 notifies a transfer of a telephone No. 3000 to the IP telephone 12 (step 120), and subsequently implements a notification sequence with each other (step 121 to step 125). The IP telephone 12 implements a call connection to be connected with the telephone No. 3000 as a transfer destination in accordance with the transfer notification sequence when the transfer notification sequence to the softphone 7 is completed (step 126 to step 129). In this way, a telephone talk with the hub built-in IP telephone 25 starts (step 130). At the same time, a transfer completion is notified to the softphone 7 (step 131, step 132). The transfer procedure in this case may be realized by utilizing the transfer function of the basic technique of the IP telephone system disclosed in FIG. 6 and the related description of JP-A-2002-199026, for example.

In the aforementioned embodiment, the cooperation between the softphone and the IP telephone has been described in relation to the incoming call of telephone. However, it is not required that the cooperation at the call as well as the telephone number information of the IP telephone are set in advance (in the case of related art, a fixed telephone to call as a call source is registered in the IP telephony etc. in advance). The telephone number information of usable IP telephone can be acquired automatically in cooperation with the PC (softphone). Therefore, the call cooperation of acquiring a telephone number can be realized, in more convenience, by using the call cooperation system from the PC in the related art, that is, using telephone book application for the PC side. As the call cooperation system, for example, a method disclosed in JP-A-2001-127902 may be employed in which transmission destination information is sent to a predetermined telephone terminal from a PC and the telephone terminal thus received with the information originates a call automatically. Alternatively, a method disclosed in JP-A-2003-283700 (corresponding to U.S. Pat. No. 6,996,226) may be employed in which the technique relating to a third party call from a server is disclosed.

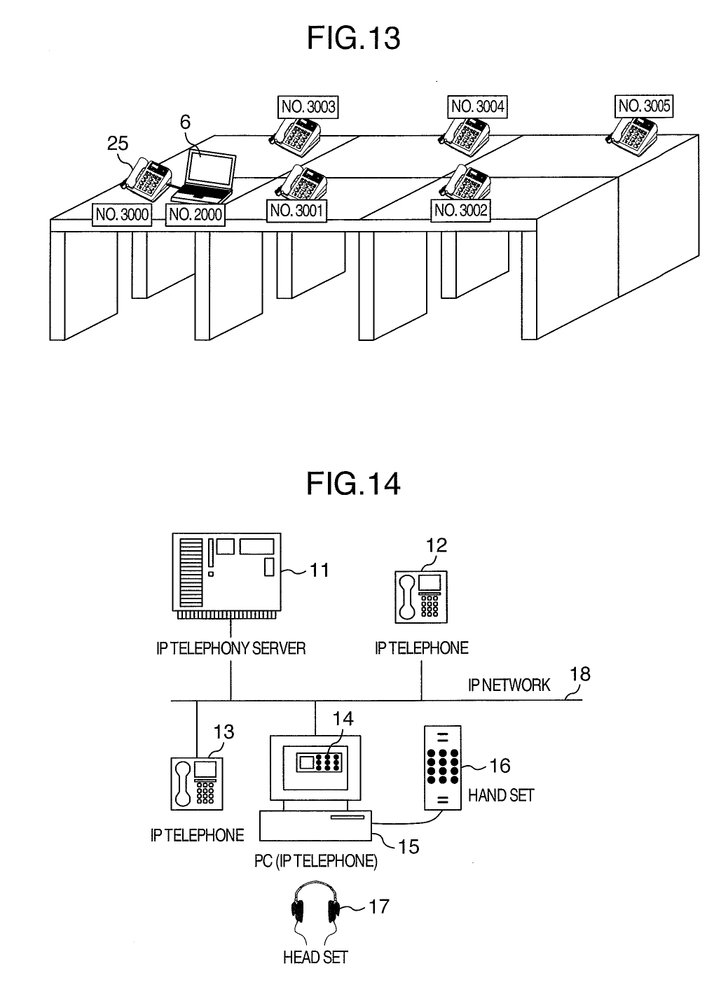

FIG. 13 is a pictorially imaged diagram showing a layout-free office style. Using this diagram, a utilization concept of the invention in a practical office will be described below.

In FIG. 13, a plurality of office desks are arranged to work for business. The hub built-in IP telephones 25 are installed on each of the desks. Telephone numbers of 3000s digit are allotted to the telephones 25, respectively, that is, No. 3000, No. 3001, No. 3002, No. 3003, No. 3004, and No. 3005, respectively. Employees do not have their own desks and seats, respectively, and their policy is that each employee can take a favorite desk in every morning to work for business. Therefore, when they come into the office in the morning, each employee takes out own PC from a locker room, takes a favorite seat, connects the PC to the hub built-in IP telephone 25 installed on the desk, and then works for business. A softphone is installed in the PC distributed to every employee, and an exclusive number of an employee who uses the PC is also allocated to a telephone number of every PC. Here, No. 2000 as an exclusive telephone number for an employee who uses the PC is assigned thereto.

According to the foregoing work style, the PC (softphone) 6 or softphone-mounted PC 6 is only connected to the hub built-in IP telephone 25 (No. 3000) when the IP telephone in the invention is used, so that the telephone 25 can be used in substitution for a handset of the softphone. That is, a call directed to the No. 2000 softphone is transferred automatically to the No. 3000 telephone 25 by the system in the invention. Therefore, a call directed to the No. 3000 telephone 25, as well as to the No. 2000 PC (softphone) 6 can be connected to talk with the easy-to-use desk telephone 25. At this time, the call directed to the 2000 softphone is made reply to a call source by the PC (softphone) 6 once, and then transferred to the IP telephone 25, so that the incoming call notification can be displayed on the softphone screen of the PC (softphone) 6, and the PC (softphone) 6 can determine easily for the call to which of the telephone numbers has been directed to, the No. 2000 or No. 3000. Further, it is possible that means for notifying the call, to which of the telephone numbers has been directed to, can be mounted easily on the IP telephone 25 by cooperation between the IP telephone 25 with the PC (softphone) 6.

Finally, an embodiment will be described for an optimal substitute response in the layout-free office style in which the IP telephone in the invention is used. Normally, in order to carry out a substitute response, it is required that telephone numbers to be able to carry out the substitute response are specified and set as group settings in the IP telephony server.

However, in the case of considering the layout-free office style which is assumed that the seats for the employees are changed in everyday, there is a problem with the group setting which cannot be set practically because it is unknown that the employees who sit on which of seats is paired with a desk. For this reason, there arises a problem with the substitute response that its response cannot be carried out to a call directed even to a neighboring softphone.

The present invention attempts to solve the foregoing problems. Therefore, it makes use of effect to automatically transfer a call directed to the softphone to the IP telephone, and only the telephone numbers of IP telephones arranged on the desks are set in a group setting or settings every land-like group of the seats.

Specifically, the respective telephone numbers on the desk-installed fixed IP telephones (No. 3000, No. 3001, No. 3002, No. 3003, No. 3004, and No. 3005) are registered in the IPT server 11 as a group setting in advance, as shown in FIG. 13. In this way, a call directed to the No. 2000 softphone is automatically transferred to the No. 3000 IP telephone. The No. 3001 IP telephone being set in the group setting can therefore respond to the incoming call as a substitute response. This causes the foregoing problems to be solved as described above.

Particularly, when business organizations introduce the layout-free office environment, a highly convenient IP telephone and IP telephone system can be provided for the business organizations.

It should be further understood by those skilled in the art that although the foregoing description has been made on embodiments of the invention, the invention is not limited thereto and various changes and modifications may be made without departing from the spirit of the invention and the scope of the appended claims.

1. An IP telephone network system, comprising: a personal computer cooperative with a softphone built therein; an IP telephone connectable with the personal computer; an IP telephony server that manages the personal computer and terminals including the IP telephone, and implements a call control for a telephone call between the terminals; and an IP network connected with the terminals and the IP telephony server, further comprising:
a unit that notifies telephone number information of the IP telephone to the personal computer when the personal computer is connected with the IP telephone; and
a unit that transfers an arrived call to the IP telephone of the telephone number information when the call directed to the personal computer is arrived from an IP telephone of a predetermined call source, wherein
the transfer destination IP telephone allows the call directed to the personal computer to be responded to the call.

2. The system according to claim 1, wherein the IP telephone includes a hub built-in IP telephone, and the notification unit notifies automatically the telephone number information of the IP telephone to the personal computer, when the personal computer is connected to the IP telephone.

3. The system according to claim 1, wherein the telephone number information notification unit is provided in the IP telephone, and a unit that transfers the arrived call is provided in the personal computer.

4. An IP telephone cooperative with an IP network and a softphone, and connectable with a personal computer having a built-in softphone, comprising:
a unit that notifies own telephone number information to the personal computer when the IP telephone is connected with the personal computer; and
a unit that receives a call arrived from the personal computer when the call arrives to the personal computer from a call source IP telephone, wherein an IP telephone function is provided so that a telephonic exchange is allowed between the IP telephone and the call source IP telephone in accordance with the call.

5. The IP telephone according to claim 4, wherein the IP telephone includes a hub built-in IP telephone, and the hub built-in IP telephone includes the telephone number information notification unit that notifies automatically telephone number information of the IP telephone to the personal computer, when the personal computer is connected with the IP telephone.

6. A personal computer cooperative with a softphone built therein, comprising:
an interface unit connectable with an IP telephone;
a storage unit that receives and saves telephone number information of the IP telephone, when the personal computer is connected with the IP telephone; and
a unit that transfers a call from a call source IP telephone to the IP telephone, when the call arrives from the call source IP telephone, wherein a telephonic exchange is allowed between the call source IP telephone and the IP telephone in accordance with the call.

7. An IP telephoning method, comprising the steps of:
transferring second telephone number information of an IP telephone to a personal computer, when the personal computer cooperating with a softphone built therein and having first telephone number information is connected with the IP telephone having second telephone number information;
receiving a call by the softphone in the personal computer, when the call is directed to the personal computer from an opponent party IP telephone;
making a call connection between the opponent party IP telephone and the softphone, when the softphone in the personal computer responds to the call, and making a telephonic exchange between the opponent party IP telephone and the softphone allowed;
notifying that a telephone number directed to the softphone in the personal computer is transferred to a telephone number of the second telephone number information, to the opponent party IP telephone from the softphone in the personal computer; and
making a call connection with a transfer destination IP telephone having the second telephone number information, when the opponent party IP telephone receives the transfer notification, and making a telephonic exchange between the opponent party IP telephone and the IP telephone allowed.
